(19) United States
(12) Patent Application Publication
(10) Pub. No.: US 2007/0180113 A1
(43) Pub. Date: Aug. 2, 2007

(54) Distributing load of requests from clients over multiple servers

(76) Inventor: Jeroen Van Bemmel, Leiden (NL)

Correspondence Address: WILLIAMS, MORGAN & AMERSON, 10333 RICHMOND, SUITE 1100, HOUSTON, TX, 77042, US

(21) Appl. No.: 11/344,523

(22) Filed: Jan. 31, 2006

(51) Int. Cl. G06F 15/173

(52) U.S. Cl. 709/226

(57) ABSTRACT

The present invention provides a method and an apparatus for balancing load of a plurality of requests from at least one of first and second clients between a first and a second server. The method comprises comparing the load of the plurality of requests to a threshold of processing requests at the first server to determine whether the first server can process the plurality of requests. The method further comprises selectively redirecting a set of requests from the plurality of requests to the second server based on a policy associated with the first server, if the first server can not process the plurality of requests based on the threshold.

### FIELD OF THE INVENTION

This invention relates generally to telecommunications, and more particularly, to wireless communications.

### DESCRIPTION OF THE RELATED ART

Many communication systems provide different types of services to users of processor-based devices, such as computers or laptops. In particular, data communication networks may enable such device users to exchange peer-to-peer and/or client-to-server messages, which may include multi-media content, such as data and/or video. For example, a user may access Internet via a Web browser. A request by a client for the user involves establishment of a connection between a source device through a number of network routers that incrementally advance a message towards its destination to a target device. For example, on a wide area network (WAN), a network address may identify a particular node (e.g., a server node). By examining a destination network address of a request, network routers forward the request along a path from the request's source to the request's destination.

Load distribution is a common technique to divide incoming requests from one or more clients (e.g. web page requests, database operations, etc.) over a number of identical servers. This situation occurs when the load generated by clients is too large to be handled by a single server (in terms of required processing power, network bandwidth, etc.). In addition, duplication of servers may be done for redundancy reasons, for example, when one server fails, another server may take over without having detrimental impact on clients.

Some of the common load distribution techniques include static distribution and dynamic distribution. In static distribution, each client is assigned a distinct server to handle all its requests, typically dividing clients evenly across all servers. The distribution of load of requests can be done once or each time a client starts a new connection (although sometimes the latter technique is considered to be dynamic). Rather, dynamic distribution is performed as requests come in, and may be handled by a dedicated network element that redirects each request to a server or by an intermediary proxy that forwards each request transparently. The former case relies on redirect semantics in an application protocol and is noticeable to clients, while the latter is transparent. Distribution may be performed according to a predetermined policy, e.g., always picking the least-loaded server. A hybrid approach is also sometimes used, e.g., using N proxies to which clients are assigned dynamically, while using static distribution amongst the servers behind the proxies.

As one example, for load distribution, in The 3rd Generation Partnership Project (3GPP) standard compliant Internet Protocol (IP) multimedia subsystem (IMS) architecture based system, an optional Subscriber Location Function (SLF) element is defined, which redirects all requests for a particular user by providing the address of a Home Subscriber Server (HSS) server to contact. The HSS server may provide a database for the Public Land Mobile Network (PLMN) to support a number of subscribers. The HSS server may provide variables and identities for establishing and maintaining calls and sessions for subscribers. Moreover, web server farms may be provided behind a battery of redirectors, network elements that distribute Transmission Control Protocol (TCP) connection requests over all available servers using a round-robin or least-loaded strategy. The TCP may enable two servers to establish a connection and exchange streams of data.

However, static distribution is inflexible and fails to provision redundancy. A predictable and non-varying load from each client is desired, and all clients must be known in advance. Proxy based solutions add latency to the request processing and may rely on more than one proxy to avoid creating a single point of failure. As a result, distribution of clients over proxies is needed. Redirect-based solutions add even more latency, i.e., a full round-trip time to handle each request.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method of balancing load of a plurality of requests from at least one of first and second clients between a first and a second server. The method comprises comparing the load of the plurality of requests to a threshold of processing requests at the first server to determine whether the first server can process the plurality of requests. The method further comprises selectively redirecting a set of requests from the plurality of requests to the second server based on a policy associated with the first server, if the first server can not process the plurality of requests based on the threshold.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a telephony system associated with a data communications network for balancing load of a plurality of requests from at least one of first and second clients between a first and a second server in accordance with one embodiment of the present invention;

FIG. 2 schematically depicts one embodiment of the telephony system, as shown in FIG. 1, such as an Internet Protocol (IP) multimedia subsystem for dynamically distributing requests from a plurality of clients over a plurality of servers; and

FIG. 3 illustrates a stylized representation of a flow chart implementing a method for temporarily redirecting a set of requests to balance load of requests from at least one of first and second clients between a first and a second server consistent with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method and apparatus are provided for communication between networking elements. Requests from a plurality of clients may be dynamically distributed over a plurality of servers. In particular, a load of a plurality of requests from at least one of first and second clients may be balanced between a first and a second server. The method comprises comparing the load of the plurality of requests to a threshold of processing requests at the first server to determine whether the first server can process the plurality of requests. The method further comprises selectively redirecting a set of requests from the plurality of requests to the second server based on a policy associated with the first server, if the first server can not process the plurality of requests based on the threshold. To selectively redirect the set of requests, the first server may associate a policy with a particular client, such as the first and/or second clients. In one embodiment, a telephony system, such as an Internet Protocol (IP) multimedia subsystem (IMS) may dynamically distribute requests from a multiple clients over multiple servers. To balance a load of requests from at least one of first and second clients between a first and a second server, a server may temporarily redirect a set of requests. That is, when a processing load at a server becomes higher than a threshold of processing requests, the server may selectively redirect one or more requests to other servers that are determined to be less loaded. The servers may use state information associated with the requests for determining a level of load that a server can process for distributing requests from the plurality of clients. Sharing of the state information associated with the requests among the servers may enable a server to selectively redirect some of the requests for a desired duration of time. By balancing the load of a plurality of requests based on a selective temporary redirection of requests by the first and/or second servers, the distribution of the load may be flexible and may provide redundancy in a telecommunications system.

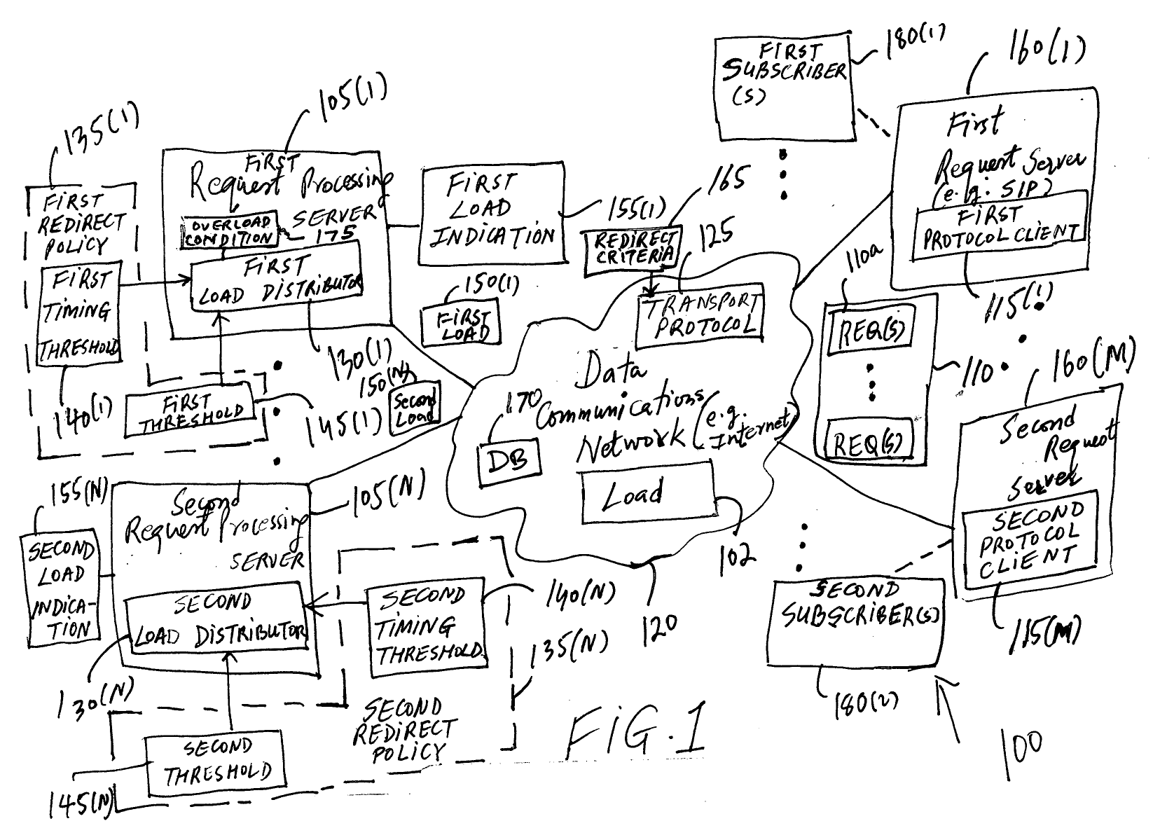

Referring to FIG. 1, a telephony system 100 is schematically depicted to include a first request processing server 105(1) and a second request processing server 105(n) that may balance load of a plurality of requests 110 from a first protocol client 115(1) and a second protocol client 115(m), according to one embodiment of the present invention. For example, the first request processing server 105(1) may selectively redirect a set of requests 110a temporarily from the first and/or second protocol clients 115(1-m) over a data communications network 120 based on a transport protocol 125.

Examples of the telephony system 100 include an IP-based multimedia subsystem (IMS) compliant with the Third Group Partnership Project (3GPP) standard. Examples of the plurality of requests 110 include network access requests, database operations, one or more requests sent by a user, one or more requests associated with an application, one or more requests related to a session that may be distributed over a number of servers, such as the first and second request processing servers 105(1, m).

While the data communications network 120 may enable the first and second protocol clients 115(1, m) to send the plurality of requests 110 to a desired recipient, the transport protocol 125 may enable the first and second request processing servers 105(1,n) to temporarily redirect one or more requests, such as the set of request 110a, in one embodiment.

Persons of ordinary skills in the art should appreciate that portions of the data communications network 120, the first and second protocol clients 115(1,m) and the first and second request processing servers 105(1,n) may be suitably implemented in any number of ways to include other components using hardware, software or a combination thereof. Data communications network, protocol clients, servers are known to persons of ordinary skill in the art and so, in the interest of clarity, only those aspects of the data communications network that are relevant to the present invention will be described herein. In other words, unnecessary details not needed for a proper understanding of the present invention are omitted to avoid obscuring the present invention.

Examples of the first and second protocol clients 115(1, m) include a Session Initiation Protocol (SIP) client based on the Diameter Protocol as specified in an Internet Engineering Task Force (IETF) standard specification. The SIP protocol may be used for setting up communications sessions on the Internet, such as telephony events, notification with instant messaging. The SIP protocol may initiate a call setup, routing, authentication and other related functions. For example, the SIP protocol may initiate an interactive user session that involves multimedia communications such as video, voice, and data.

Examples of the transport protocol 125 include the Diameter protocol having redirect semantics that allow temporary redirection of one or more related requests. The Diameter protocol may provide an Authentication, Authorization and Accounting (AAA) for network access or IP mobility. The Diameter protocol may provide local Authentication, Authorization and Accounting and in roaming situations. By using the transport protocol 125, the first request processing server 105(1), for example, may redirect all requests for a user access or all requests associated with a session “Y” to the second request processing server 105(n).

To determine whether the first request processing server 105(1) can process the plurality of requests 110, the first request processing server 105(1) may comprise a first load distributor 130(1). The first request processing server 105(1) may associate a first redirect policy 135(1) with a particular client of the first and/or second protocol clients 115 (1-m). The first redirect policy 135(1) may comprise a first timing threshold 140(1) and a first threshold 145(1) of processing requests. The first timing threshold 140 may indicate a predetermined duration for which the first request processing server 105(1) may temporarily redirect the load 102 of the plurality of requests 110 to the second request processing server 105(m). The first threshold 145(1) of processing requests may indicate a number of requests that the first request processing server 105(1) may be capable of or selected to process for the first and/or second protocol clients 115(1,m). In other words, the first threshold of processing requests 145(1) may indicate when a processing load may exceed a number of requests that may be processed by the first request processing server 105(1) as the requests reach from one or more clients 115.

The first protocol client 115(1) may be associated with the first request server 160(1) and may be based on the transport protocol 125. Likewise, the second protocol client 115(m) be associated with the second request server 160(m) and compliant with the transport protocol 125. Examples of the first and second request servers 160(1, m) include a SIP server. The first and second protocol clients 115(1, m) may generate the load 102 of the plurality of requests 110 for the first and second request processing servers 105(1, n).

In operation, the first request processing server 105(1) may receive a first load 150(1) of processing requests from the first and second protocol clients 115 (1, m). The first request processing server 105(1) may determine whether the first load 150(l) of processing the plurality of requests 110 is higher than the first threshold 145(1) of processing requests.

The first request processing server 105(1) may share a first indication 155(1) of the first load 150(1) with the second request processing server 105 (n). The first request processing server 105(1) may receive a second indication 155(n) of a second load 150(n) of processing the plurality of requests 110 from the second request processing server 105 (n). Based on the first and second indications 155(1, n), the first request processing server 105 (1) may determine whether the second load 155(n) is smaller than the first load 155(1). The first and second loads 155(1,n) may be sized relative to each other based on server of network metrics, such as processing power requirement, network bandwidth, and the like. If the second load 155(n) is determined to smaller than the first load 155(1) and the first load 155(1) is higher than the first threshold 145(1) of processing requests, the first request processing server 105(1) may temporarily redirect the first load 150(1) to the second request processing server 105 (n) for a period based on the first timing threshold 140(1).

However, the number of requests that may be redirected are desired be compliant with the transport protocol 125. That is, all the set of requests 110a are redirected if all the requests in this set match a redirection criterion or criteria 165. For example, the redirection criterion or criteria 165 may apply to all the requests for a user “X” or all the requests for a session “Y” that may be processed by a single server. In this way, the set of requests 110a may be redirected together as a group from the first request processing server 105(1) to the second request processing server 105(n).

By using the first load distributor 130(1), in one exemplary embodiment of the present embodiment, the first request processing server 105(1) may distribute at least two related requests, such as the set of requests 110a from the load 102 of the plurality of requests 110. The data communications network 120 may provide a data base (dB) 170 for storing subscriber information associated with first and second sets of subscriber(s) 180(1-2).

To distribute the set of requests 110a, the first load distributor 130(1) may use the subscriber information associated with the first set of subscriber(s) 180(1) and/or the second set of subscriber(s) 180(2). While the first set of subscriber(s) 180(1) may be associated with the first request server 160(1). The second set of subscriber(s) 180(2) may be associated with the second request server 160(m).

Consistent with another embodiment, the first load distributor 130(1) may determine whether an overload condition 175 is reached at the first request processing server 105(1) based on the first threshold 145(1) of processing requests. In response to the overload condition 175,the first load distributor 130(1) may redirect the set of requests 110a of the plurality of requests 110 to the second request processing server 105(n).

By using a single redirect action, the first load distributor 130(1) may redirect more than one requests of the plurality of requests 110 from the first request processing server 105(1). To redirect such requests, the first load distributor 130(1) may determine whether the requests received in the first load 150(1) have been received in a desired timeframe and/or are related based on a common criterion. For example, the common criterion may indicate whether the requests are associated or sent by a particular user or the requests are associated with a particular application or the requests belong to a particular session which may be associated with an application.

According to one embodiment of the present invention, to redirect one or more requests of the plurality of requests 110, the telephony system 100 may be dimensioned in a manner that enables processing of the load 102 over the first and second request processing servers 105(1-n). By using the transport protocol 125, in this way, the telephony system 100 may temporarily redirect a first set of requests, such as the requests 110a that match a given criterion. For example, the given criterion may indicate such as all the requests being associated with a single user or all users request associated with a single session that to be routed by a particular server or to be routed by a single server.

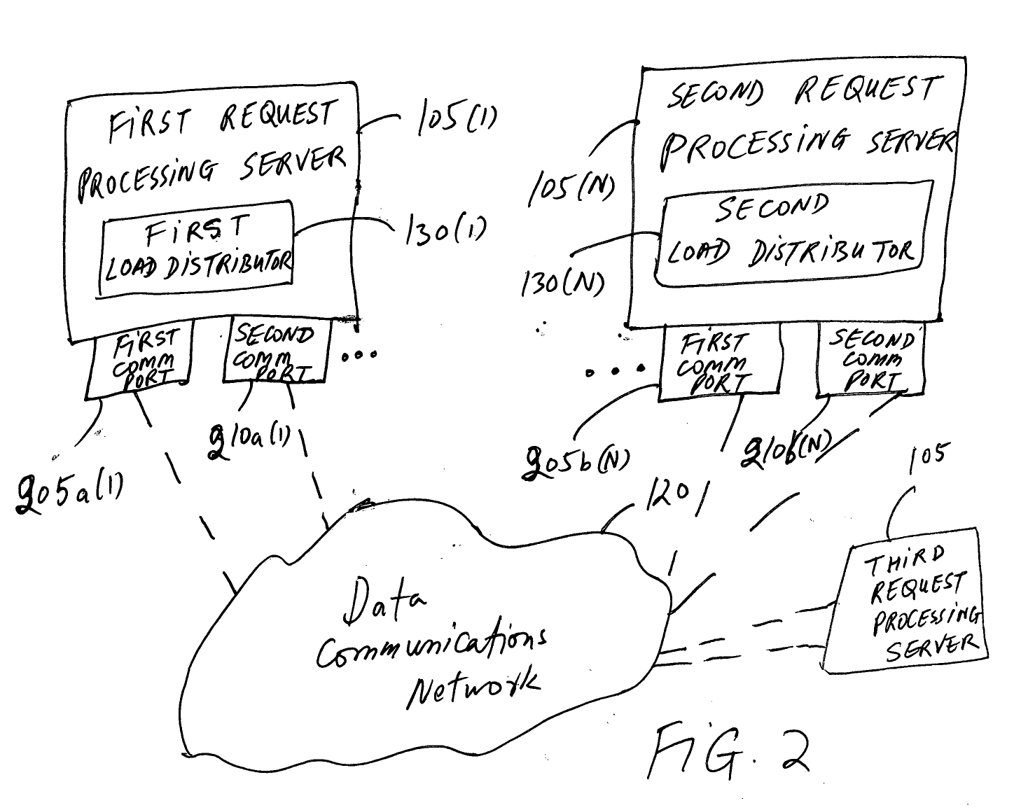

Referring to FIG. 2, first and second request processing servers 105(1,n) are schematically illustrated to include a plurality of ports 205 to redirect desired requests of the plurality of requests 110, in accordance with one embodiment of the present invention. In one embodiment, each port 205 may indicate a network input/output channel of the data communications network 120 executing a Transmission Control Protocol/Internet Protocol (TCP/IP). For example, the data communications network 120 may communicate over Internet, the port 205 may refer to a port number of the Internet a server 105 is executing on.

In particular, the first request processing server 105(1) may comprise a first communication (COMM) port 205a(1) and a second communication (COMM) port 210a(1) to redirect the load 102 shown in FIG. 1 of the plurality of requests 110. The first load distributor 130(1) may cause the first and second protocol clients 115(1, m) to use the first COMM port 205a(1) as a public port for redirecting one or more requests of the plurality of requests 110 from the first request processing server 105(1).

The second request processing server 105(n) may comprise a first COMM port 205b(n) and a second COMM port 210b(n). However, the first load distributor 130(1) may cause the first and second protocol clients 115(1,m) to use the second COMM port 210a(1) as a private port for the second request processing server 105(n) to receive one or more redirected requests of the plurality of requests from the first request processing server 105(1).

By processing the redirected requests received at the second COMM port 210a(1) of the second request processing server 105(n) without redirecting to a third request processing server 105. To process one or more redirected requests, the first request processing server 105(1) may process the redirected requests received at the second COMM port 210a(1) with a higher priority than the one or more requests of the plurality of requests 110 received at the first COMM port 205a(1) of the second request processing server 105(n).

Before selectively redirecting the plurality of requests 110 to the second request processing server 105(n), the first load distributor 130(1) may determine whether it is likely that more of the same kind of a particular type of request(s) may arrive at the first request processing server 105(1). If so, the first load distributor 130(1) may selectively redirect that particular type of request to the second request processing server 105(n), in some embodiments of the present invention. As described above, to determine whether it is likely that more of the same kind of a particular type of request(s) may arrive at the first request processing server 105(1), the first load distributor 130(1) may determine whether the particular type of request(s) is associated with a session in which a number of requests were recently received or the particular type of request(s) is a first request in the set of requests 110a associated with an application that issues a series of multiple requests.

For routing the plurality of requests 110, in one embodiment, the first request processing server 105(1) may send a redirect indication to the first and/or second protocol clients 115(1,m). The redirect indication may cause the first and/or second protocol clients 115(l,m) to cache the redirect indication for a predetermined period of time to continue to route the plurality of requests 110. For example, in response to receiving at least a portion of the load 102 of at the first request processing server 105(1) the first load distributor 130(1) may determine whether the plurality of requests 110 exceed the first threshold 145(1) of processing requests. If so, the first load distributor 130(1) may send a redirect with an address of the second request processing server 105(n) being a less-loaded server node. In one embodiment, a time period for which the first request processing server 105(n) may be sent to the second request processing server 105(n) for a specific user to redirect the load 102 of the plurality of requests 110.

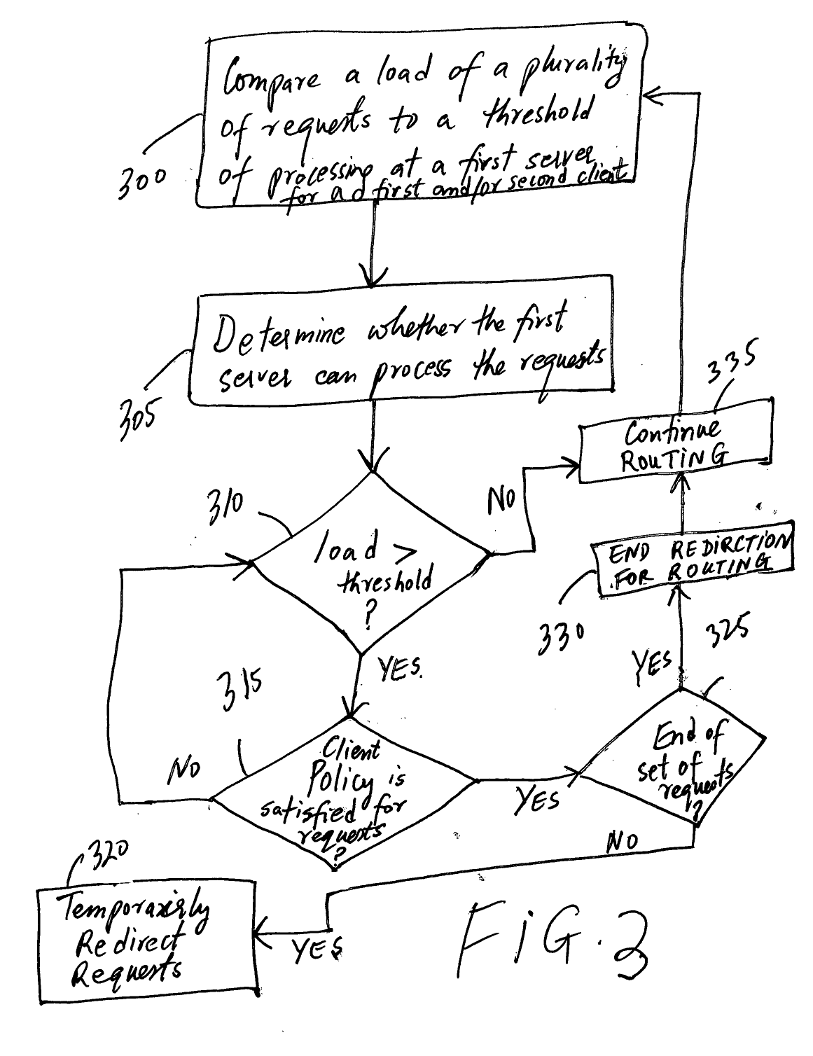

Turning now to FIG. 3, a stylized representation for implementing a method of balancing the load 102 of the plurality of requests 110 from the first and/or second protocol clients 115(1,m) between the first and second request processing servers 105(1,n) is illustrated in accordance with one embodiment of the present invention. At block 300, the first load distributor 130(1) may compare the first load 150(1) of requests to the first threshold 145(1) of processing requests. The first load distributor 130(1), at block 305 may determine whether the first request processing server 105(1) can process the plurality of requests 110 based on the first threshold 145(1) of processing requests.

A decision block 310 may determine whether the first load 150(1) exceeds the first threshold 145(1) of processing requests, for example, in terms of the number of requests that the first request processing server 105(1) may process. If the first load 150(1) exceeds the first threshold 145(1) of processing requests, the first load distributor 130(1) may determine whether the first redirect policy at a decision block 315 is satisfied for the received requests. The decision block 315 may indicate whether the first redirect policy 135(1) associated by the first request processing server 105(1) with a particular client of the first and/or second protocol clients 115(1,m) matches a given criterion or criteria for the plurality of requests 110 being received at the first request processing server 110(1).

More specifically, at the decision block 315, the first load distributor 130(1) may use the first timing threshold 140(1) to determine whether the plurality of requests 110 meet the given criterion or criteria for temporary redirection to the second request processing server 105(n). If the first redirect policy 135(1) is satisfied for the requests, the first load distributor 130(1) may temporarily redirect the set of requests 110a, as shown in block 320, to the second request processing server 105(n).

To determine the end of the set of requests 110a, which satisfy the first redirect policy 135(1), before temporarily redirecting desired requests, a decision block 325 may determine when the set of requests 110a end. Until the set of requests 110a for which the first redirect policy 135(1) is satisfied, the temporary redirection of the plurality of requests 110a may continue.

However, when redirecting of the set of requests 110a which satisfy the first redirect policy 135(1) end, the first load distributor 130(1) may again determine whether the first load 150(1) exceeds the first threshold 145(1) of processing requests. In other words, at the end of set of requests 110a, the first load distributor 130(1) may end redirection for routing the plurality of requests 110 from the first request processing server 105(1) to the second requests processing server 105(n) as illustrated in block 330. In this way, the first request processing server 105(1), at block 335, may return to routing the plurality of requests 110a directly for the first and second protocol clients 115(1,m) as shown in block 335. That is, the temporary redirection of the plurality of requests 110 may end.

Consistent with one embodiment, the first request processing server 105(1) to the second requests processing server 105(n) may communicate with the first and second protocol clients 115(1,m) over an Ethernet wired network. The transmission and reception of data may use a TCP/IP protocol, and the data communications network 120 may be connected to the Internet.

By using selective temporary redirection to balance the load 102 in that during normal operation the plurality of requests 110 may be processed by the first and second request processing servers 105(1, n) as the set of requests 110a may arrive, i.e., without redirection or proxying. Distribution of the first and/or second protocol clients 115(1,m) over the first and second request processing servers 105(1, n) may be based an initial static distribution which may be predetermined. Alternatively, the first and/or second protocol clients 115(1,m) may start with a single target server 105.

When server processing load, the first or second load 150(1), 150(n) becomes higher than a set threshold 145, the server 105 may selectively redirect requests to other servers that are determined to be less loaded (e.g., by using shared state information regarding the requests). The state information may indicate at least one characteristic of the plurality of requests 110, such as the set of requests 110a received in a sufficiently large timeframe are related based on a desired common criteria. For example, the common criteria may indicate that the requests are sent by the same user or application, belong to the same application session, or the like. The telephony system 100 may be suitably dimensioned, i.e., the total processing capacity is sufficient to deal with the actual load, ensuring that a less-loaded server may be ideally available for processing an overload of requests.

The transport protocol 125 having redirect semantics that enable temporary redirection of all requests matching a given criterion, in one embodiment, may provide a selective temporary redirection to distribute Diameter Cx/Sh requests over a distributed HSS function (a kind of database containing subscriber information in cellular networks). The fact that the HSS server node is distributed may be hidden from clients (Interrogating-Call/Session Control Function (I-CSCF) and Serving-Call/Session Control Function (S-CSCF) elements), which expect a single point of contact with a possible backup for failover. The interface between the I-CSCF and the HSS server node and between the S-CSCF and the HSS sever node is called Cx interface, and is based on the Diameter protocol. The interface between the I-CSCF and the SLF and between the S-CSC and the SLF is called Dx interface and, like the CX interface, is based on the Diameter protocol.

When processing the load 102 at a HSS server node, such as the first and second request processing servers 105(1, n) exceeds the set threshold 145, a Diameter protocol compliant redirect may be sent with the address of a less-loaded server node. In addition, a time period for which the redirection should hold is added, and information on the associating criterion of subsequent requests (for example: “redirect this and all other requests for this user to node S2, for a period of 10 minutes”) may be attached. To avoid redirection of the requests that get redirected again, each HSS server node may use at least two communication (COMM) ports 205, 210, i. e., one ‘public’ port which is given to the clients 115 and may use redirection, and one ‘private’ port to which redirected requests from other nodes are sent. Requests received on the latter port may ideally be processed with a higher priority since they already suffered some extra delay and not redirected.

An alternative embodiment of the present invention may use selective redirection on requests for which it is likely that “more of the same kind” will follow, e.g., for a session in which “R” requests were recently received or because it is a first request in an application-specified series of multiple requests. The redirection occurs for requests (coming from the same client) after the one that is being redirected. That is, a client 115 may cache a received redirect indication for the provided period of time, and use this information in routing of the plurality of requests 110.

For the purposes of a temporary redirection, one or more appropriate parameters may include information regarding a ratio of a number of protocol clients 115 and a number of request processing servers 105, statistical distribution of the plurality of requests 110 and corresponding average load per protocol client 115, and statistical distribution of related requests (i.e., in which timeframe are related requests likely to occur). If the number of protocol clients 115 is much greater than the number of request processing servers 105 and each protocol client 115 generates approximately the same load, an initial static evenly divided distribution may provide selective redirect for a sudden burst from a single protocol client, such as the first protocol client 115(1).

Accordingly, the telephony system 100 use of temporary, selective redirection for the purpose of load balancing and may further use of two COMM ports 205, 210 per server node, one public and one private, to avoid redirection of redirected requests as described above. In one embodiment, temporary selective redirection may avoid adding latency and overhead to request processing unlike use of proxy that redirects each request by default. Upon detection of the overload condition 175 at a server node, such as the first request processing server 105(1), the set of requests 110a may be redirected in such a way that it is likely that more than one request is redirected by a single redirect action from the first request processing server 105(1).

In one embodiment, the first load distributor 140(1) may use a selective temporary redirect algorithm with an exemplary policy of using a least-loaded server as follows:

```
processRequest(Request r) {
  if (currentLoad > threshold) {
    target t = determineLeastLoadedServer( ); // this is the target's
    private port address
    sendRedirect(r, t, SAME_SESSION, 120 seconds);
  } else {
    ++currentLoad;
    processLocally(r);
    --currentLoad;
  }
}
```

The selective temporary redirect algorithm may be tuned using a desired threshold redirect criterion and redirect time period values. Those skilled in the pertinent art and having ordinary skill will recognize that further optimizations may be possible in specific applications, e.g., use of load information shared between server nodes need only be approximately accurate and one could define a minimal unused load check for the leastLoadedServer. Other many such variations in the selective temporary redirect algorithm are readily possible, however, are considered within the scope and spirit of the present invention.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11 (a), 802.11 (b), 802.11 (g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of balancing load of a plurality of requests from at least one of first and second clients between a first and a second server, the method comprising:
comparing said load of said plurality of requests to a threshold of processing requests at said first server to determine whether said first server can process said plurality of requests; and
if said first server can not process said plurality of requests based on said threshold, selectively redirecting a set of requests from said plurality of requests to said second server based on a policy associated with said first server.

2. A method, as set forth in claim 1, wherein comparing said load of said plurality of requests to said threshold of processing requests further comprises:
receiving a first load of processing said plurality of requests from said at least one of first and second clients at said first server; and
determining whether said first load of processing said plurality of requests is higher than said threshold of processing requests.

3 . A method, as set forth in claim 2, further comprising:
sharing a first indication of said first load of processing said plurality of requests with said second server; and
receiving a second indication of a second load of processing said plurality of requests from said second server.

4. A method, as set forth in claim 3, further comprising:
determining whether said second load of processing said plurality of requests is smaller than said first load of processing said plurality of requests based on said first and second indications; and
if said second load of processing said plurality of requests is smaller and said first load of processing said plurality of requests is higher than said threshold of processing requests, temporarily redirecting at least two of said plurality of requests to said second server.

5. A method, as set forth in claim 1, further comprising:
distributing a first set of requests from said load of said plurality of requests based on a database of subscriber information in a data communications network.

6. A method, as set forth in claim 1, further comprising:
determining whether an overload condition is reached at said first server based on said threshold of processing requests; and
in response to said overload condition, redirecting one or more requests of said plurality of requests to said second server.

7. A method, as set forth in claim 6, wherein redirecting one or more requests of said plurality of requests further comprises:
using a single redirect action from said first server to redirect more than one request of said plurality of requests.

8. A method, as set forth in claim 6, wherein redirecting one or more requests of said plurality of requests further comprises:
receiving said one or more requests at said first server; and
determining whether said one or more requests received in a desired timeframe are related based on a common criterion of at least one of sent by a particular user, a particular application and belongs to a particular application session.

9. A method, as set forth in claim 6, wherein redirecting one or more requests of said plurality of requests further comprises:
dimensioning a telephony system to enable processing of said load of said plurality of requests over said first and second servers.

10. A method, as set forth in claim 1, further comprising:
providing a transport protocol to enable temporary redirection of a first set of requests of said plurality of requests that match a given criterion of at least one of all requests being associated with a first user or all users request for operating in a single session.

11. A method, as set forth in claim 1, further comprising:
in response to said load of said plurality of requests at said first server exceeding said threshold of processing requests, sending a redirect with an address of said second server being a less-loaded server node.

12. A method, as set forth in claim 11, wherein sending a redirect further comprises:
sending an indication of a time period for which said first server to redirect said load of said plurality of requests to said second server for a user.

13. A method, as set forth in claim 1, further comprising:
using a first and a second communication port at each server of said first and second servers to redirect said load of said plurality of requests.

14. A method, as set forth in claim 13, wherein using a first and a second communication port at each server further comprises:
causing said first and second clients to use said first communication port as a public port for redirecting one or more requests of said plurality of requests from said first server.

15. A method, as set forth in claim 13, wherein using a first and a second communication port at each server further comprises:
causing said first and second clients to use said second communication port as a private port for said second server to receive one or more redirected requests of said plurality of requests from said first server.

16. A method, as set forth in claim 15, wherein causing said first and second clients to use said second communication port as a private port further comprises:
processing said one or more redirected requests received at said second communication port of said second server without redirecting to a third server.

17. A method, as set forth in claim 16, wherein processing said one or more redirected requests further comprises:
processing said one or more redirected requests received at said second communication port of said second server with a higher priority than said one or more requests of said plurality of requests received at said first communication port of said second server.

18. A method, as set forth in claim 1, wherein selectively redirecting said plurality of requests to said second server further comprises:
determining whether it is likely that more of the same kind of a particular type of request of said plurality of requests will arrive at said first server; and
if so, selectively redirecting said particular type of request to said second server.

19. A method, as set forth in claim 1, wherein determining whether it is likely that more of the same kind of a particular type of request further comprises:
determining whether said particular type of request is associated with at least one of a session in which a number of requests were recently received or said particular type of request is a first request in a set of requests associated with an application that issues a series of multiple requests.

20. A method, as set forth in claim 19, further comprising:
sending a redirect indication to at least one of said first and second clients;
causing said at least one of said first and second clients to cache said redirect indication for a predetermined period of time for routing said plurality of requests.
